(19) United States
(12) Patent Application Publication
(10) Pub. No.: US 2010/0032968 A1
(43) Pub. Date: Feb. 11, 2010

(54) MOTOR ARRANGEMENT

(76) Inventors: Denis Cavallucci, Otterswiller (FR); Gurbinder S. Kalsi, West Midlands (GB); Chris Rhodes, Orleans (FR); Nigel V. Spurr, Solihull (GB); Sylvain Rehi Chonavel, Thury Harcourt (FR); David Peatey, Solihull (GB); Paul Moore, Birmingham (GB); Robert F. Tolley, Staffordshire (GB); Jean-Vincent Olivier, Villegusien (FR); Robert James Clawley, Staffordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 12/306,379

(22) PCT Filed: Jun. 29, 2007
(86) PCT No.: PCT/GB2007/002454

§ 371 Date: Oct. 7, 2009

(30) Foreign Application Priority Data
Jun. 29, 2006 (GB) 0612930.8

(51) Int. Cl. E05B 15/02; H02K 7/10

(52) U.S. Cl. 292/341.16; 310/75 R

(57) ABSTRACT

A motor arrangement includes a rotor with a north rotor magnetic pole and a south rotor magnetic pole, the rotor being rotatable about a rotor axis between a first rotor position and a second rotor position. The rotor includes a first rotor abutment and a second rotor abutment. The motor arrangement includes a stator having a first stator magnetic pole and a second stator magnetic pole, the stator having a first stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole. The first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole. The motor arrangement includes an output member rotatable about the rotor axis and having a first output abutment engageable by the first rotor abutment to move the output member in a first rotational direction and having a second output abutment engageable by the second rotor abutment to move the output member in a second rotational direction. The output member is rotatable relative to the rotor to a limited extent defined by the first and second output abutments and the first and second rotor abutments. The motor arrangement includes a first stop to limit movement of the rotor past the first rotor position and a second stop to limit movement of the rotor past the second rotor position.

### REFERENCE TO RELATED APPLICATION

This application is a National Phase Application of PCT/GB2007/002454 filed Jun. 29, 2007, which claims priority to United Kingdom Application No. 0612930.8 filed Jun. 29, 2006.

### BACKGROUND OF THE INVENTION

The present invention relates to a motor arrangement, and in particular a motor arrangement suitable for changing the state of a latch assembly, in particular releasing or locking/unlocking a latch assembly, in particular a latch assembly for use with car doors and car boots.

Latch assemblies are known to releasably secure car doors in a closed position. Operation of an inside door handle or an outside door handle will release the latch allowing the door to open. Subsequent closure of the door will automatically relatch the latch.

In order to ensure that rain does not enter the vehicle, the doors are provided with weather seals around their peripheral edge which close against an aperture in the vehicle body in which the door sits. In addition to providing protection from rain, the weather seals also reduce the wind noise. The ongoing requirement for improved vehicle occupant comfort requires minimizing of wind noise which in turn requires the weather seals to be clamped tighter by the door. The door clamps the seals by virtue of the door latch and accordingly there is a tendency for the seal load exerted on the latch to be increased in order to meet the increased occupancy comfort levels required. Because the seal forced on the latch is increased, then the forces required to release the latch are correspondingly increased.

UK patent application GB0330264 shows a latch mechanism in which a primary pawl is operable to hold a rotating claw in a closed position. The primary pawl is mounted on a toggle link, and the toggle link is held in position (when the latch is closed), either directly or indirectly by a secondary pawl. The motor arrangement of the present invention, when applied to a latch assembly, can be utilized to move the secondary pawl.

Latch assemblies are also known to include motors which can be actuated to lock and unlock the latch. Other known latch assemblies include motors which can put the latch into a child safety on condition i.e., a condition where operation of an inside door handle does not open a latch. The motor can also be used to put the latch into a child safety off condition, i.e., a condition whereby operation of the inside door handle does open the latch.

Thus, according to the present invention there is provided a latch arrangement as defined in the accompanying independent claims.

### SUMMARY OF THE INVENTION

A motor arrangement includes a rotor with a north rotor magnetic pole and a south rotor magnetic pole, the rotor being rotatable about a rotor axis between a first rotor position and a second rotor position. The rotor includes a first rotor abutment and a second rotor abutment. The motor arrangement includes a stator having a first stator magnetic pole and a second stator magnetic pole, the stator having a first stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole. The first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole. The motor arrangement includes an output member rotatable about the rotor axis and having a first output abutment engageable by the first rotor abutment to move the output member in a first rotational direction and having a second output abutment engageable by the second rotor abutment to move the output member in a second rotational direction. The output member is rotatable relative to the rotor to a limited extent defined by the first and second output abutments and the first and second rotor abutments. The motor arrangement includes a first stop to limit movement of the rotor past the first rotor position and a second stop to limit movement of the rotor past the second rotor position.

### BRIEF DESCRIPTION OF THE DRAWINGS

The invention will now be described, by way of example only, with reference to the accompanying drawings in which:

FIGS. 1, 1A, 1B, 1D and 1D′ shows a view taken from the backplate side of a latch showing certain components of a latch arrangement including a motor arrangement according to the present invention, in a closed position;

FIG. 1C show a view taken from a retention plate side of the latch showing certain components of the latch arrangement of FIG. 1 in a closed position;

FIGS. 2A, 2A′, 2A″, 2B, 2B′, 2B″, 2C, 2C′ and 2C″ show certain components of FIG. 1 while the latch is being opened;

FIG. 3 shows certain components of the latch of FIG. 1 in an open position;

FIG. 4 shows certain components of the latch of FIG. 1 during closing;

FIGS. 5 and 5′ show the motor arrangement of FIG. 1 according to the present invention;

FIGS. 5A to 5D shows the motor arrangement of FIG. 5 in various positions;

FIGS. 6 to 8 show a further embodiment of the motor arrangement according to the present invention;

FIGS. 9 and 10 show a further embodiment of the motor arrangement according to the present invention; and

FIG. 11 shows a torque output from the motor arrangement according to the present invention.

### DETAILED DESCRIPTION OF THE PREFERRED EMBODIMENT

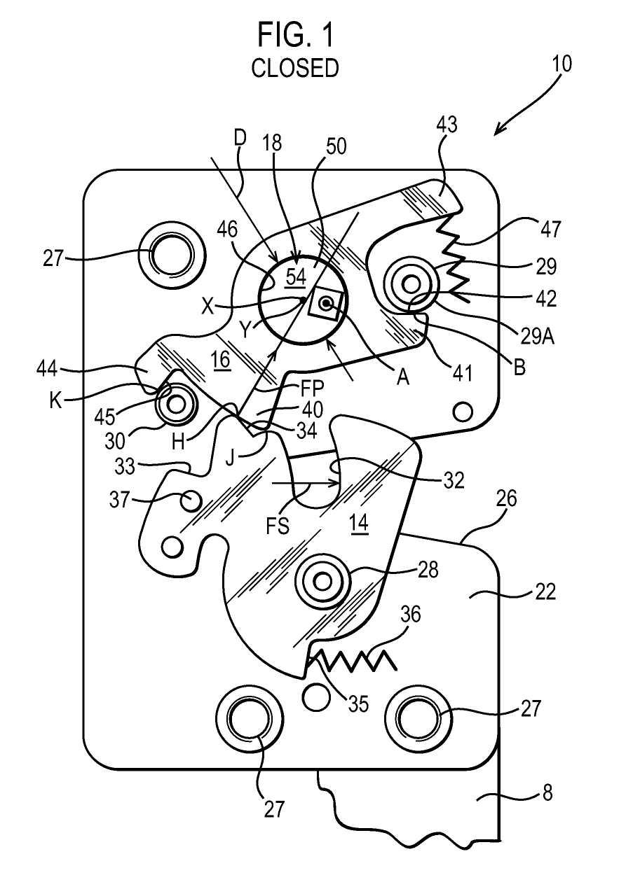

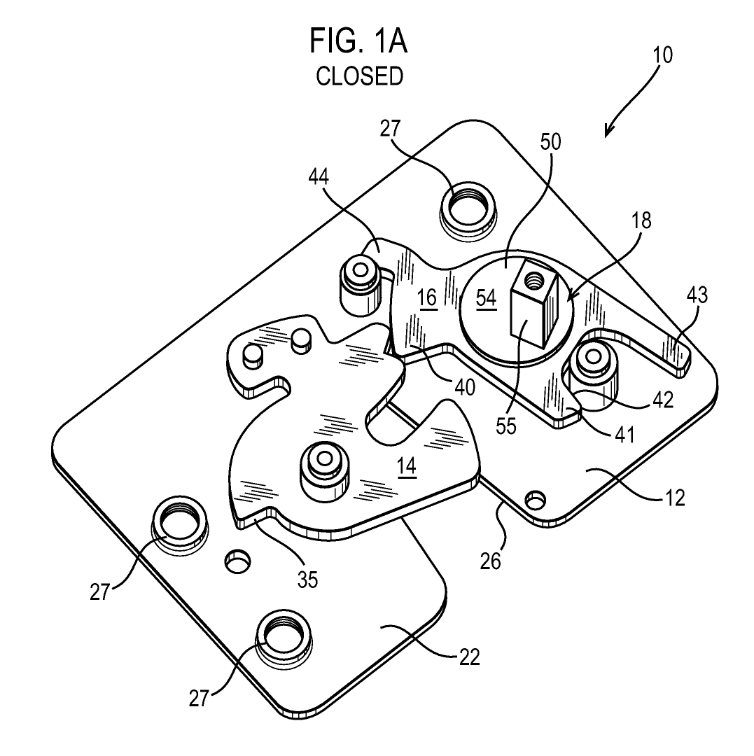

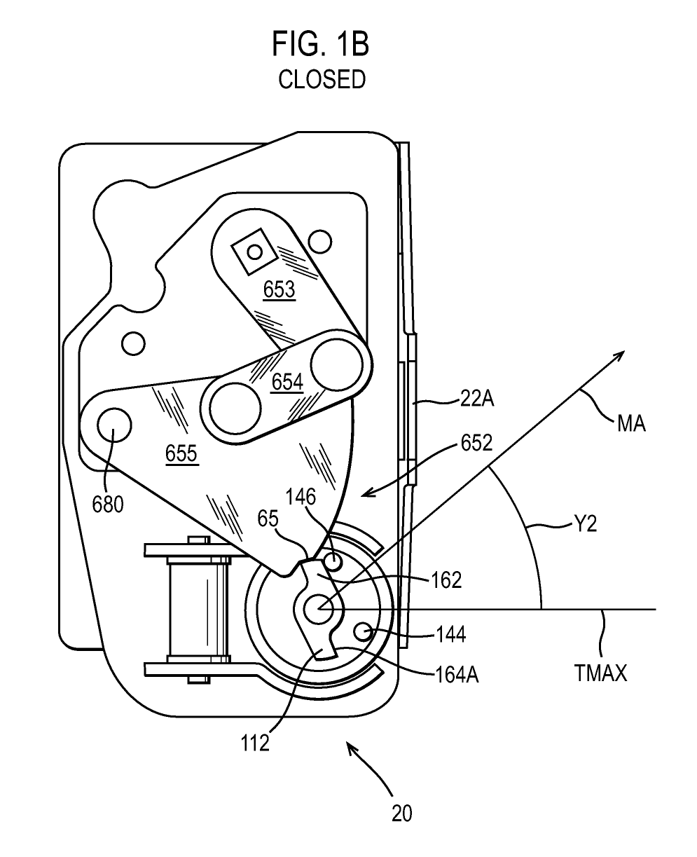

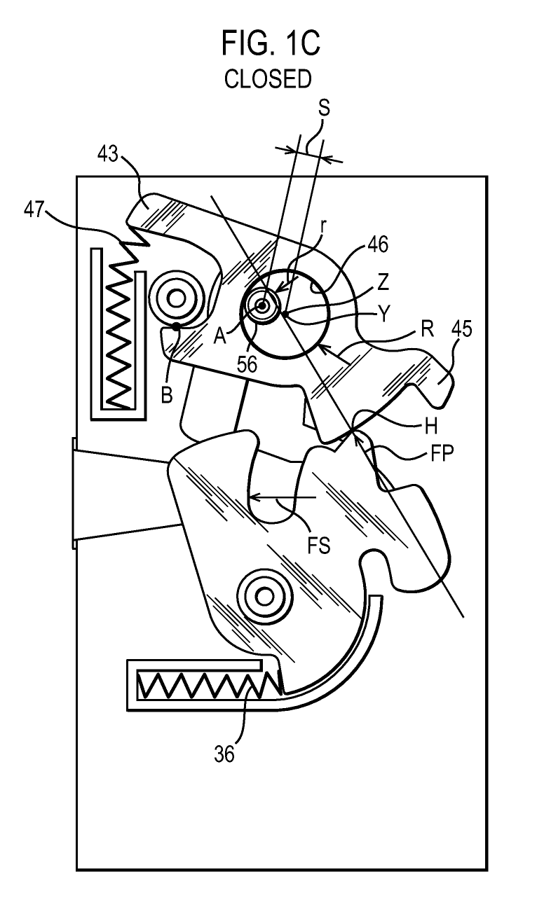

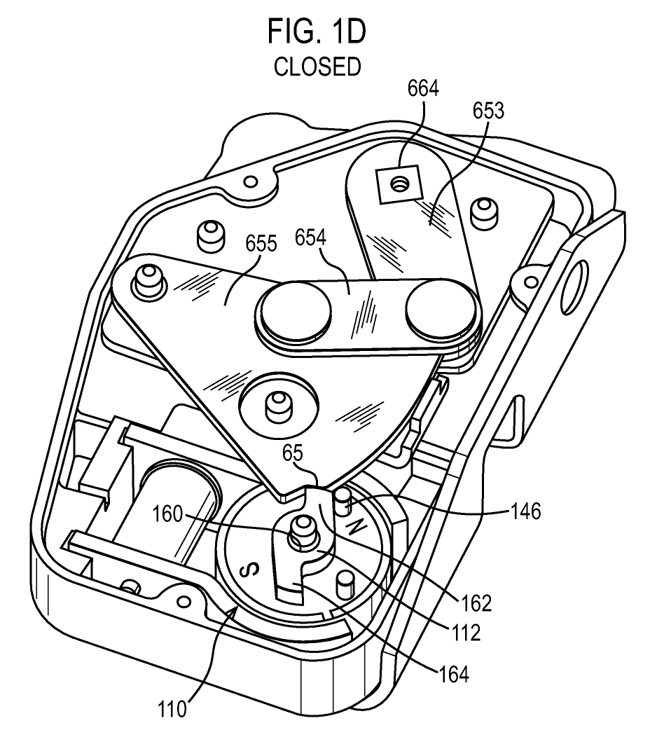

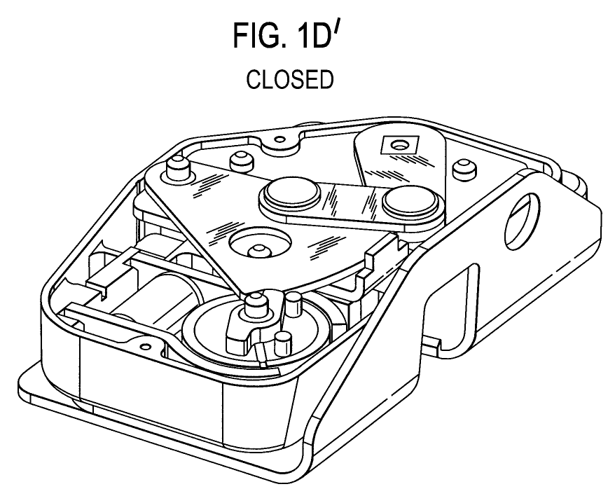

With reference to the FIGS. 1 to 5, there is shown a latch assembly 10, the major components of which are a latch chassis 12, a latch bolt in the form of a rotating claw 14, a compression pawl 16, an eccentric arrangement in the form of a crank shaft assembly 18, and a release actuator assembly 20. The latch assembly 10 is mounted on an associated door 8 (only shown in FIG. 1).

The major components of the latch chassis 12 are a retention plate 22 and a backplate 24. The retention plate 22 is generally planar (but having an up turned edge 22A). The generally planar portion includes a mouth 26 for receiving a striker (not shown). The retention plate 22 includes three threaded holes 27, which in use are used to secure the latch assembly 10 to the door. Projecting from the retention plate 22 is a claw pivot pin 28 and stop pins 29 and 30. The stop pin 29 is fixed relative to the latch chassis 12 and includes a cylindrical outer surface 29A, the purpose of which will be described below.

The backplate 24 includes holes 31A, 31B and 31C for receiving ends of the claw pivot pin 28, the stop pin 29 and the stop pin 30, respectively. During assembly, the ends of the claw pivot pin 28 and the stops pins 29 and 30 are peened over to secure the backplate 24 relative to the retention plate 22.

The rotating claw 14 is pivotally mounted on a claw pivot pin 28 and includes a mouth 32 for receiving the striker, a first safety abutment 33, and a closed abutment 34. A spring abutment 35 is engaged by a spring 36 to bias the rotating claw 14 towards its open position. The rotating claw 14 is generally planar and includes a reset pin 37 which projects out of general plane of the rotating claw 14.

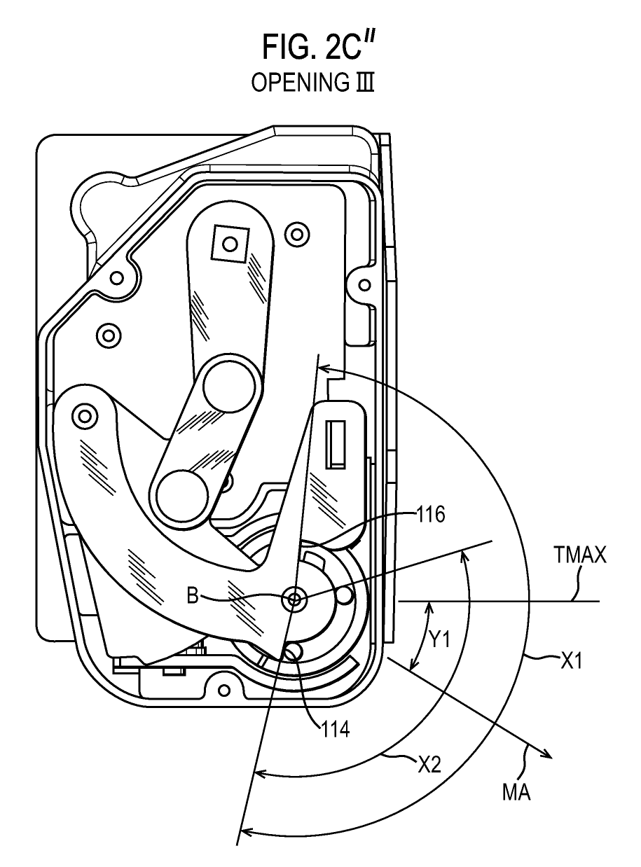

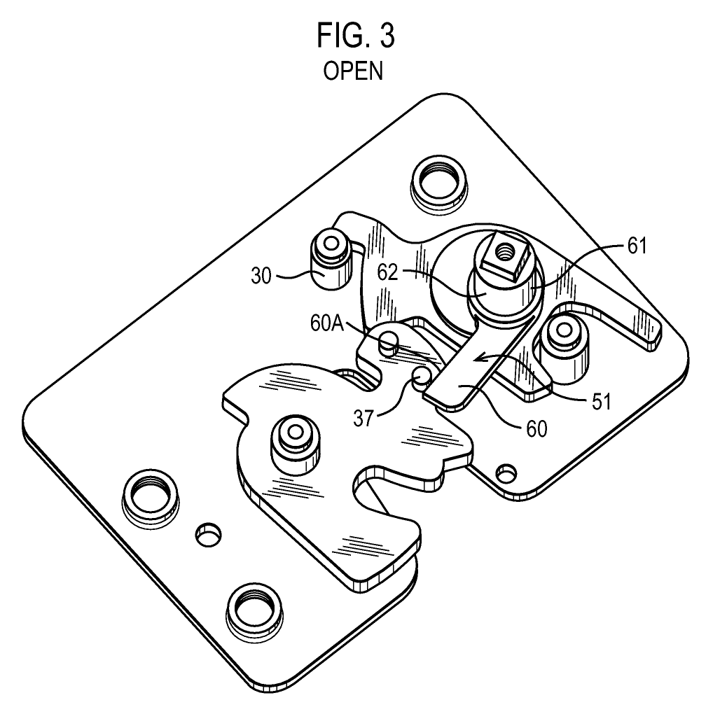

The compression pawl 16 includes a pawl tooth 40, a first arm 41 having an abutment surface 42, a second arm 43, a third arm 44 having an abutment surface 45. The compression pawl 16 also has a pawl pivot hole 46 of an internal diameter D. The compression pawl 16 is biased in a clockwise direction when viewing FIG. 1C about axis Y (see below) by a spring 47 engaging the second arm 43. The stop pin 30 acts to limit rotation of the compression pawl 16 in a counter-clockwise direction when viewing FIG. 3 by engaging the third arm 44.

The major components of the crank shaft assembly 18 are a crank shaft 50, a reset lever 51, and a release lever 653. The crank shaft 50 includes a crank pin 54 in the form of disc having a crank pin axis Y. A square shaft 55 projects from one side of the crank pin 54, and a cylindrical pin 56 projects from the other side of the crank pin 54. The square shaft 55 and the cylindrical pin 56 together define a crank shaft axis A. The cylindrical pin 56 is rotatably mounted in a hole (not shown) of the retention plate 22. The retention plate 22 thereby provides a bearing for the cylindrical pin 56.

The diameter of the crank pin 54 is a running fit in the pawl pivot hole 46, i.e., the diameter of the crank pin 54 is slightly less than the internal diameter D. The radius of the crank pin 54 is R. A crank pin axis Y therefore defines a pawl axis about which the compression pawl 16 can rotate (see below). The thickness of the crank pin 54 is substantially the same as the thickness of the compression pawl 16.

The reset lever 51 includes an arm 60 and a boss 61 secured to the arm 60. The boss 61 has a cylindrical outer surface 62 and a central hole of square cross section. Accordingly, when the boss 61 is assembled onto the square shaft 55 as shown in FIG. 3, then the arm 60 becomes rotationally fast with the crank shaft 50. The cylindrical outer surface 62 of the boss 61 is mounted in a hole in the backplate 24, which thereby provides a bearing surface for the cylindrical outer surface 62. The cylindrical outer surface 62 and the outer surface of the cylindrical pin 56 are concentric and together define the crank shaft axis A. The arm 60 includes an edge 60A (also known as a reset abutment) which interacts with the reset pin 37, as will be described further below.

A release arrangement 652 includes of three major components, namely the release lever 653, a link 654 and a lever 655. The release lever 653 includes a square hole 664 mounted on the square shaft 55. Thus, the release lever 653 is rotationally fast with the crank shaft 50.

The lever 655 is pivotally mounted on a pivot pin 680, which in turn is secured to the latch chassis 12. The lever 655 includes a release abutment 65. A link 654 is pivotally mounted to the release lever 653 and is also pivotally mounted to the lever 655.

A bolt and washer (not shown) is screwed into threaded hole 57 of the square shaft 55 to secure the crank shaft 50, the reset lever 51 and the release lever 653 together. Accordingly, the crank shaft 50, the reset lever 51 and the release lever 653 are all rotationally fast relative to each other.

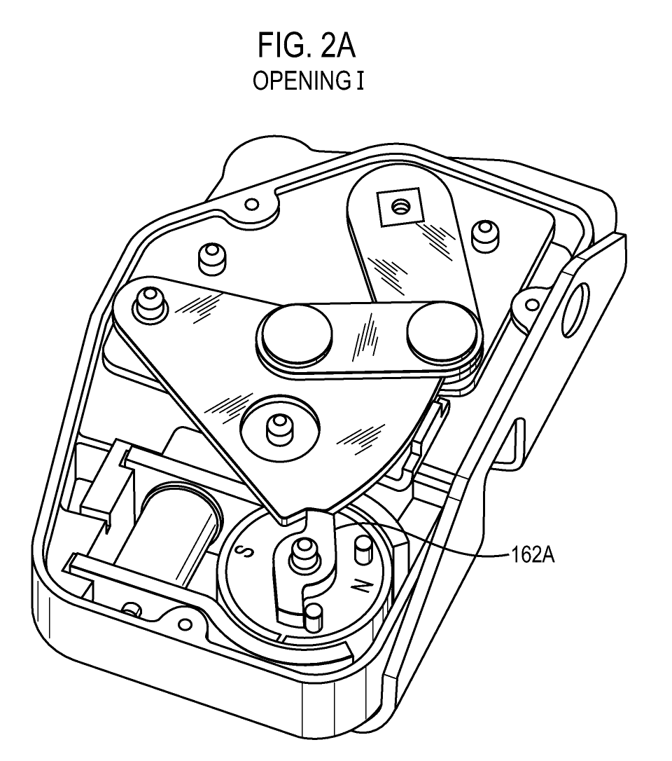

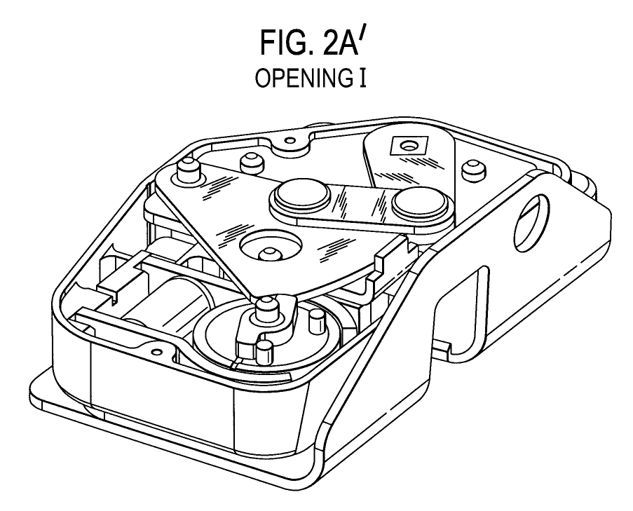

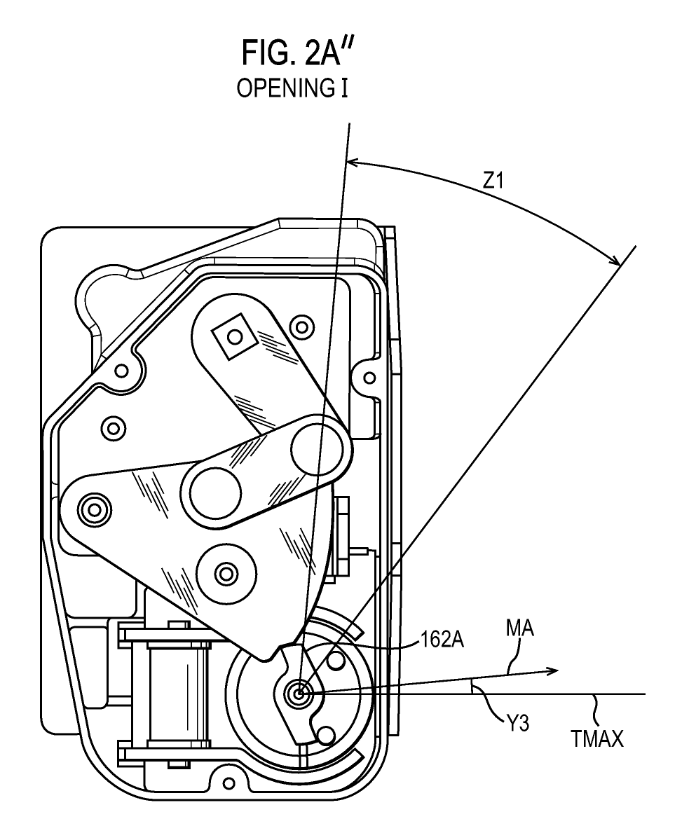

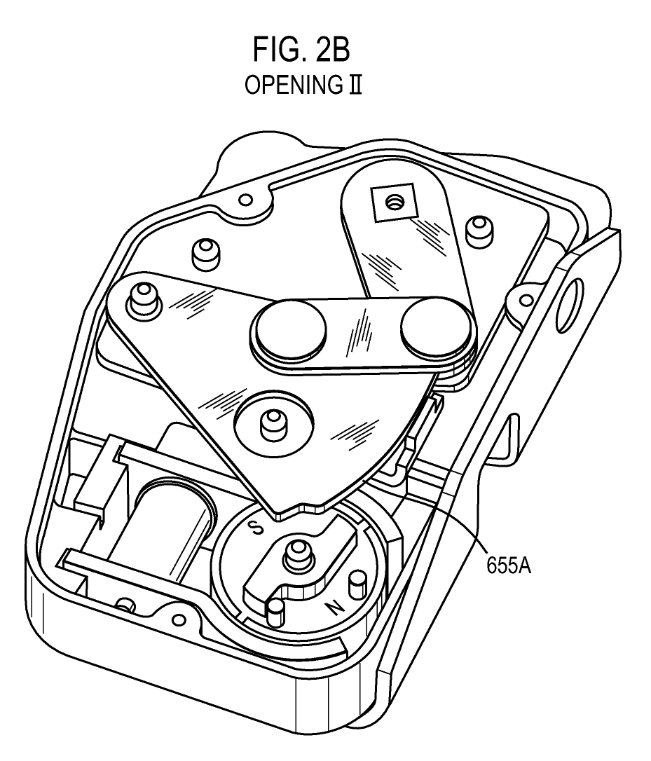

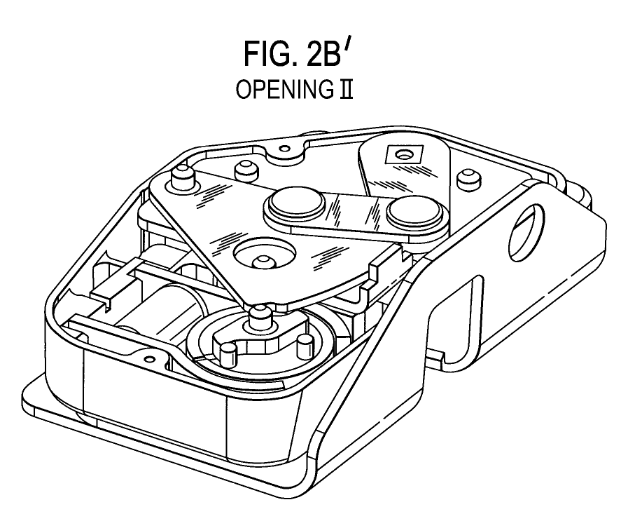

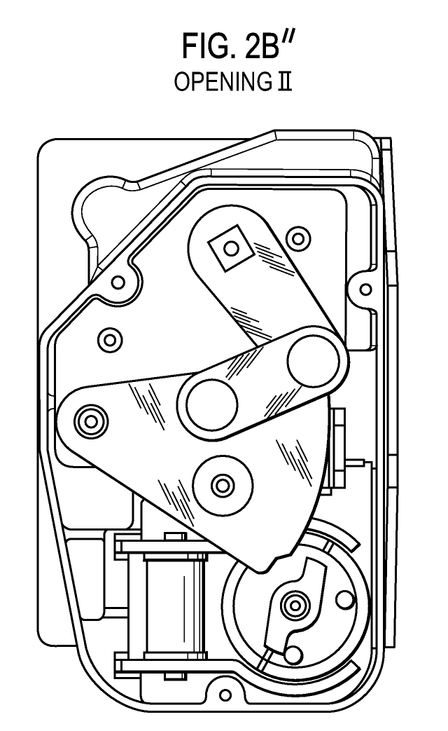

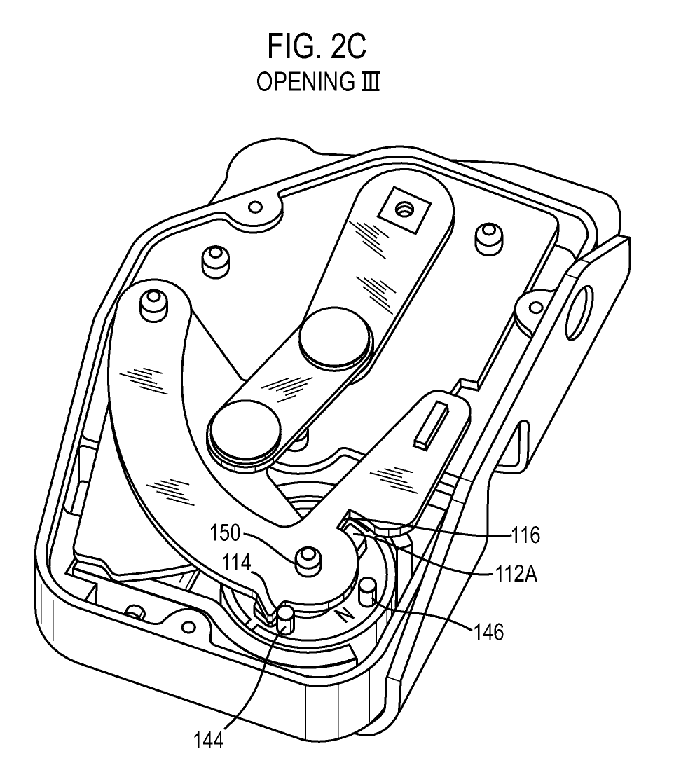

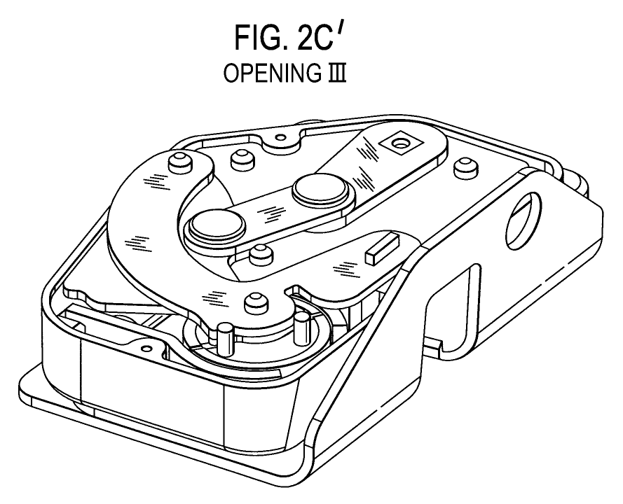

When assembled, the crank pin 54 and the reset lever 51 are positioned between the retention plate 22 and the backplate 24, with the cylindrical outer surface 62 of the boss 61 being rotationally mounted in a hole (not shown) of the backplate 24. The release lever 653 lies on an opposite side of the backplate 24 to the reset lever 51 and the crank pin 54 (best seen in FIG. 2A).

The latch assembly 10 includes a release actuator assembly 20 in the form of a motor arrangement 100. The motor arrangement 100 includes a brushless DC motor 110, an output member 112 (also known as a movable abutment) and motor stops 114 and 116. The brushless DC motor 110 includes a stator 118 and a rotor 120.

The stator 118 includes an electromagnetic coil 122 having a coil axis A. The electromagnetic coil 122 is mounted on a ferromagnetic core 124, which extends through a bore in the electromagnetic coil 122. An end 124A of the ferromagnetic core 124 is connected to a first stator arm 126, and a second end 124B of the ferromagnetic core 124 is connected to a second stator arm 128. The first stator arm 126 and the second stator arm 128 extend generally perpendicularly to the coil axis A. Furthermore, the first stator arm 126 and the second stator arm 128 extend in the same direction (i.e., towards the rotor 120) from the ferromagnetic core 124. The first stator arm 126 and the second stator arm 128 are made from a ferromagnetic material. An end 126A of the first stator arm 126 remote from the ferromagnetic core 124 defines a first stator magnetic pole 130, which partially surrounds the rotor 120 and in this case is generally arcuate. A first end 128A of the second stator arm 128 remote from the ferromagnetic core 124 defines a second stator magnetic pole 132, which also partially surrounds the rotor 120 and in this case is generally arcuate.

The portion of the first stator arm 126 and the second stator arm 128 proximate the ferromagnetic core 124 is generally flat. In this case, each stator arm 126 and 128 is made from a rectangular blank of sheet metal, which is then subsequently formed to provide the arcuate stator magnetic poles 130 and 132. When the electromagnetic coil 122 is supplied with a DC current (as will be further described below), then either the first stator magnetic pole 130 becomes a north pole, in which case the second stator magnetic pole 132 will become a south pole, or the first stator magnetic pole 130 will be a south pole, in which case the second stator magnetic pole 132 will be a north pole. Clearly, the polarity of the stator poles can be selected, depending upon the polarity of the connection of the coil terminals to the DC power source.

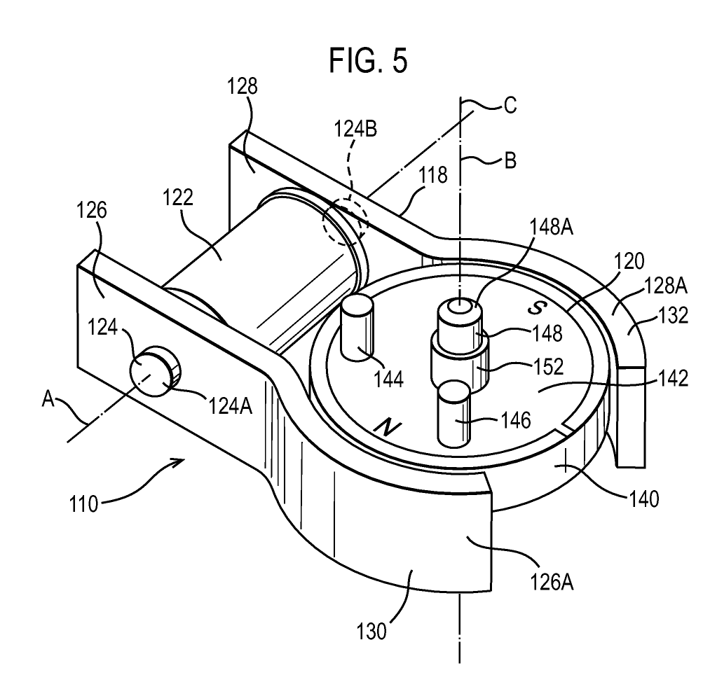

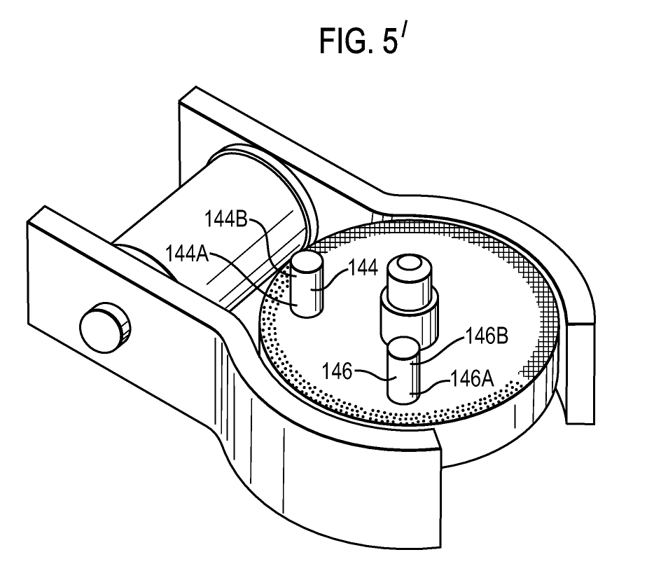

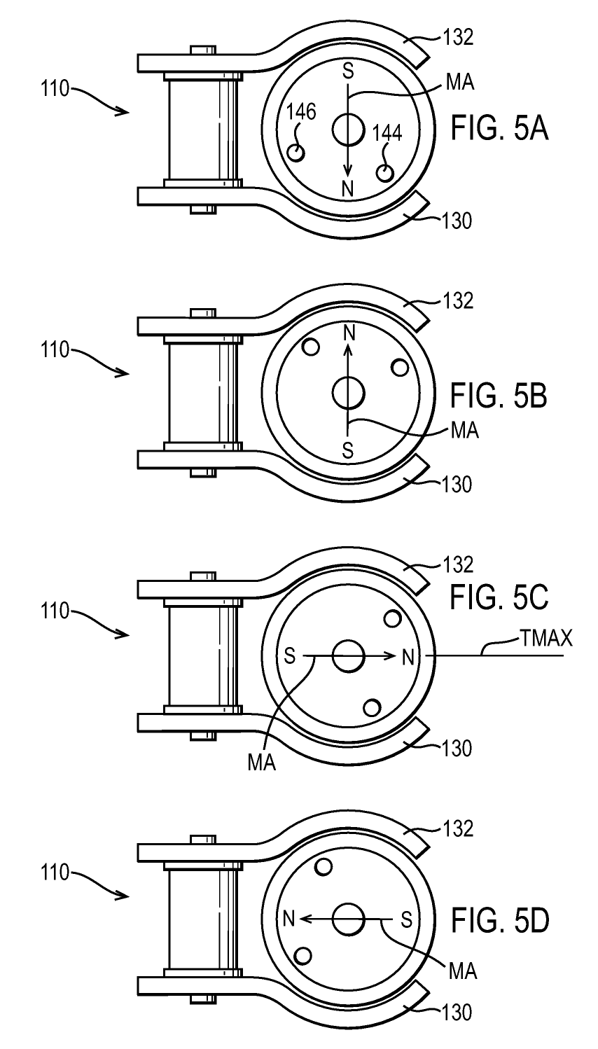

The rotor 120 includes a ring magnet 140, which in this case is a permanent magnet. Accordingly, the ring magnet 140 has a north pole N and a south pole S. An arrow MA shows the magnetic axis MA of the ring magnet 140, (i.e., an arrow passing through the south pole and north pole of the ring magnet 140). The ring magnet 140 is mounted on a rotor core 142, which preferably is a ferromagnetic core. The rotor core (and hence the ring magnet 140) are rotatably mounted about a rotor axis B. In this case, an axis C of the ring magnet 140 is coincident with the rotor axis B, though in further embodiments this need not be the case. In particular, manufacturing tolerances may result in the ring magnet 140 being offset slightly from the rotor axis B, but this is not significant in terms of the operation of the motor arrangement. As can be seen from FIG. 5, the north rotor magnetic pole is situated on one side of the rotor axis B, and the south rotor magnetic pole is situated on another side, in this case the opposite side of the rotor axis B.

Projecting generally upwardly (when viewing FIG. 2) from the rotor core 142 i.e., projecting in a direction generally parallel with the rotor axis B, is a first peg 144 and a second peg 146, the purpose of which will be described further below. The first peg 144 has a portion 144A proximate to the rotor 120 and a portion 144B remote from the rotor 120. Similarly, the second peg 146 has a portion 146A proximate to the rotor 120 and a portion 146B remote from the rotor 120.

As mentioned above, the rotor 120 is rotatable about the rotor axis B, and this is enabled by virtue of a rotor axle 148 upon which is mounted the rotor core 142. The rotor axle 148 has a first end 148A, which is rotatably mounted in a hole 150 of a plate 151 and is secured in a fixed position relative to the latch chassis 12. An opposite end of the rotor axle 148 is similarly located in a further hole. In summary, the ring magnet 140, the rotor core 142 and the rotor axle 148 all rotate together, as will be further described below.

The rotor axle 148 also includes a cylindrical surface 152, which acts as a bearing surface for the output member 112. The output member 112 includes a central circular hole 160, which is mounted on the cylindrical surface 152. The output member 112 further includes a first arm 164 and a second arm 162. The first arm 164 includes a first abutment 164A engageable by the portion 144A of the first peg 144, and the second arm 162 includes a second abutment 162 A engageable by the portion 146 A of the second peg 146, as will be described further below. The second arm 162 acts as a secondary pawl for the release arrangement 652.

The second arm 162 is presented opposite to the release abutment 65 when the latch is in the closed position as shown in FIG. 1B. In summary, to release the latch, the output member 112 is pivoted out of the path of the release abutment 65 (as shown in FIG. 2B), thereby allowing the release abutment 65 to pivot to the position shown in FIG. 2B.

FIG. 5 shows the motor arrangement 100 in isolation, i.e., prior to assembly into the latch assembly 10. It is shown in one rest position with the north rotor magnetic pole N being directly opposite the first stator magnetic pole 130 and the south rotor magnetic pole S being directly opposite the second stator magnetic pole 132. Note that in this rest position, the electromagnetic coil 122 is not energized, and hence the first stator magnetic pole 130 and the second stator magnetic pole 132 are neutral i.e., they are neither a north pole nor a south pole.

Nevertheless, because the first stator magnetic pole 130 and the second stator magnetic pole 132 are made from a magnetic material (in this case a ferromagnetic material), if the rotor 120 is close to the FIG. 5 position, then the rotor 120 will rotate to the FIG. 5 position such that the north pole N is directly opposite the first stator magnetic pole 130 and the south pole S is directly opposite the second pole. FIG. 5A is a plan view of the motor arrangement shown in FIG. 5. The rotor position shown in FIGS. 5 and 5A are identical.

The position shown in FIG. 5A is a “stable equilibrium” position. Thus, if the rotor 120 was rotated slightly from the FIG. 5A position and then released, it would return to the FIG. 5A position.

FIG. 5B shows an alternative “stable equilibrium” position wherein the north rotor magnetic pole N is adjacent the second stator magnetic pole 132 and the south rotor magnetic pole S is adjacent the first stator magnetic pole 130. The rotor 120 position shown in FIGS. 5A and 5B are 180 degrees apart. The rotor 120 position in FIG. 5B is also a stable equilibrium position because if the rotor 120 was rotated slightly from this position and released, the rotor 120 would return to this position.

FIGS. 5C and 5D also show the rotor 120 in an equilibrium position, however, in both cases this is an unstable equilibrium position. Thus, if the rotor 120 is positioned in the FIG. 5C position and rotated slightly (say 10 degrees) in a clockwise direction and then released, it would move to the stable equilibrium position shown in FIG. 5A. Conversely, if starting at the FIG. 5C position the rotor 120 was rotated slightly (say 10 degrees) in a counter-clockwise direction and released, it would then move to the stable equilibrium position shown in FIG. 5B.

Similar, if the rotor 120 is positioned as shown in FIG. 5D and rotated slightly in a clockwise direction, it will move to the FIG. 5B position when released, and if rotated slightly in a counter-clockwise direction, it will move to the FIG. 5A position when released.

The motor arrangement shown in FIGS. 5, 5A, 5B, 5C and 5D are all in isolation, i.e., prior to assembly into the latch assembly 10. When assembled into the latch assembly 10, stops (as will be described below) prevent the rotor 120 from achieving the FIG. 5A position, the FIG. 5B position, or the FIG. 5D position. Furthermore, when assembled into the latch, the rotor 120 only ever moves through the FIG. 5C position and is never stationary in this position.

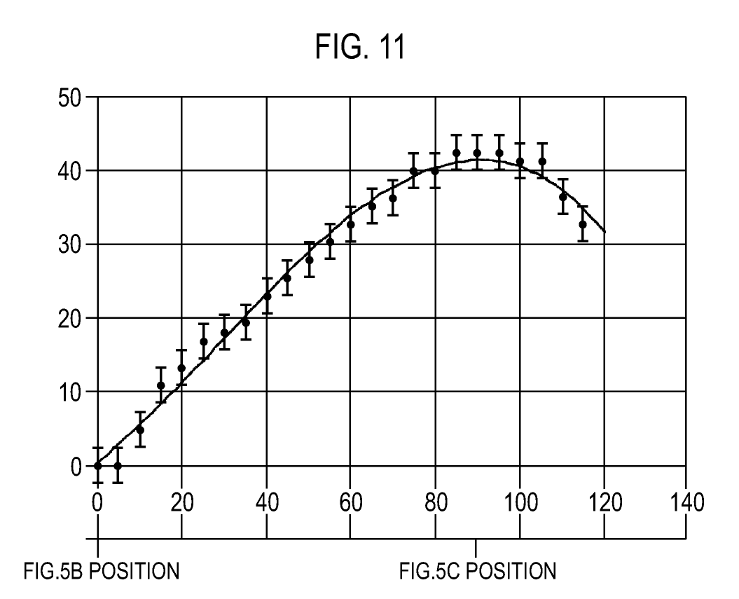

The torque output from the rotor 120 is not constant. FIG. 11 shows test results and an averaged line of torque output against rotor angle. Zero degrees represents the position shown in FIG. 5B, and 90 degrees represents the position shown in FIG. 5C. Applying a current to the coil when the rotor is in the FIG. 5B position produces zero torque. However, the torque output reaches a maximum value when the magnetic axis MA of the rotor 120 is aligned with a line TMAX, as shown in FIG. 5C. In other words, when the motor is being powered, the maximum torque occurs when the rotor 120 is in its unstable equilibrium position as defined when the rotor is unpowered. Note that the line is not linear, rather as the rotor angle approaches the 90 degree position the curve flattens out. This means that 90% of the maximum torque is still achieved at a 70 degree rotor angle, and 80% of the maximum torque is still achieved at a 60 degree rotor angle.

When the brushless DC motor 110 is assembled into the latch assembly 10, the remote portions 144B and 146B of the first peg 144 and the second peg 146, in conjunction with the motor stops 114 and 116, ensure that the rotor 120 never achieves the positions shown in FIG. 5, 5A, 5B or 5D. Thus, FIG. 2C shows the limit of clockwise rotation of the rotor 120 since the remote portion 144B of the first peg 144 is in engagement with the motor stop 114. FIG. 1D shows the limit of counter-clockwise rotation of the rotor 120 since the remote portion 146B of the second peg 146 is in engagement with the motor stop 116 (the motor stop 116 is not shown in FIG. 1D).

It can be seen from FIG. 2C″ that the angle X1 subtended at the rotor axis B between the motor stops 114 and 116 is approximately 190 degrees. The angle X2 subtended between the remote portion 114B of the first peg 144 and the remote portion 146B of the second peg 146 that engage the motor stops 114 and 116 is approximately 120 degrees. Therefore, the total angle through which the rotor 120 can move is approximately 70 degrees.

As mentioned above, prior to the brushless DC motor 110 being assembled into the latch, the rotor 120 has two stable equilibrium positions, i.e., it has one stable equilibrium position as shown in FIGS. 5 and 5A and a second stable equilibrium position as shown in FIG. 5B. In this case, these are the only two stable positions and hence the rotor is bistable, but in further embodiments this need not be the case. These two stable equilibrium positions are 180 degrees apart. When the motor is assembled into the latch, the rotor 120 still has two distinct stable equilibrium positions, one as shown in FIG. 2C and the other as shown in FIG. 1D. However, these stable equilibrium positions are approximately 70 degrees apart since, as mentioned above, the rotor 120 is restricted to turning through only 70 degrees.

Consideration of FIG. 2C″ shows that the rotor position (see the magnetic axis MA) is approximately 30 degrees rotated clockwise from the maximum torque position TMAX (i.e., the position shown in FIG. 5C), i.e., the angle Y1 between TMAX and MA is 30 degrees. In the absence of any current passing through the electromagnetic coil 122, the magnetic forces act on the rotor 120 when in the FIG. 2C position and create a torque on the rotor 120, turning it in a clockwise direction. This torque is reacted by remote portion 144B of the first peg 144 engaging the motor stop 114. Similarly, when the rotor 120 is in the FIGS. 1B and 1D position, the magnetic axis MA is angled 40 degrees (angle Y2=40 degrees) counter-clockwise from the maximum torque position TMAX. Hence, there is a torque acting on the rotor 120 in a counter-clockwise direction, and this torque is reacted by the remote portion 146B of the second peg 146 engaging the motor stop 116.

FIG. 1B shows the second peg 146 in engagement with the second abutment 162A, and the first peg 144 being spaced from the first abutment 164A. FIG. 2A″ shows the rotor 120 having being rotated clockwise through angle Z1 (in this case approximately 35 degrees). In FIG. 2A″, the second peg 146 is spaced from the second abutment 162A, and the first peg 144 is in contact with the first abutment 164A. Thus, it is apparent that the rotor 120 can rotate relative to the output member 112 to a limited extent as defined by the position of the abutments on the output member 112 and by the position of the abutments on the rotor 120. In this case, the output member 112 can rotate approximately 35 degrees relative to the rotor 120.

Consideration of FIGS. 1 to 1D show the latch assembly 10 and the associated door 8 in a closed condition. The rotating claw 14 is in a closed position, retaining the striker (not shown). The compression pawl 16 is in an engaged position whereby the pawl tooth 40 is engaged with the closed abutment 34, thereby holding the rotating claw 14 in its closed position. The weather seals of the door are in a compressed state, and the striker therefore generates a seal force FS on the mouth 32 of the rotating claw 14, which tends to rotate the rotating claw 14 in a clockwise direction when viewing FIG. 1 (a counter-clockwise direction when viewing FIG. 1C).

Force FS in turn generates a force FP onto the pawl tooth 40 and hence onto the compression pawl 16. The force FP in turn is reacted by the crank pin 54 of the crank shaft 50. The force FP reacted by the crank pin 54 is arranged to produce a clockwise (when viewing FIG. 1) torque (or turning moment) on the crank shaft 50 about the crank shaft axis A (a counter-clockwise torque when viewing FIG. 1C). However, the crank shaft assembly 18 is prevented from rotating clockwise when viewing FIG. 1 (counter-clockwise when viewing FIG. 1C) by virtue of the engagement between the release abutment 65 of the release lever 52 and the first arm 162 (see FIG. 1B).

As shown in FIG. 1D, the magnetic forces on the rotor 120 create a torque in a counter-clockwise direction (since no current is flowing through the electromagnetic coil 122). As mentioned above, this torque is reacted by the motor stop 116, but in particular the proximate portion 146B of the second peg 146 has engaged and moved the second arm 162 to the position shown in FIG. 1D i.e., to a position where it faces the release abutment 65 and therefore holds the release arrangement 652 in place.

In order to release the latch, electric current is supplied to the electromagnetic coil 122, which creates a magnetic force which causes the first stator magnetic pole 130 to become a south magnetic pole and causes the second stator magnetic pole 132 to become a north magnetic pole. This causes a clockwise torque on the rotor since north pole N is repelled from second stator magnetic pole 132 and attracted to first stator magnetic pole 130 and the south pole S is repelled from first stator magnetic pole 130 and attracted to the second stator magnetic pole 132.

FIGS. 2A, 2B and 2C show the sequence of events that occur during opening of the latch. Note that the rotor 120 moves continuously from the FIG. 1D position to the FIG. 2B position i.e., at no point between the FIG. 1D position and FIG. 2B position does the rotor 120 stop moving.

Thus, as shown in FIG. 2A″, the rotor 120 has rotated approximately 35 degrees clockwise (angle Z1=35 degrees) such that the proximate portion 144A of the first peg 144 has engaged but not yet moved the first arm 164. The second arm 162 is still in engagement with the release abutment 65.

The rotor 120 continues to rotate in a clockwise direction a further approximately 35 degrees to the position shown in FIG. 2B. It can be seen that the second arm 164 has been engaged and moved by the proximate portion 144A of the first peg 144. As shown in FIG. 2B, the output member 112 has rotated approximately 35 degrees in a clockwise direction when compared with FIG. 2A. This results in the second arm 162 disengaging from the release abutment 65.

Thus, FIG. 2B shows the moment at which the second arm 162 has disengaged from the release abutment 65, but prior to the release arrangement 652 beginning to move. Once the second arm 162 has disengaged from the release abutment 65, the lever 655 is free to rotate clockwise to the position shown in FIG. 2C. Note that the release arrangement 652 moves to the position shown in FIG. 2C as a result of the force FP that was reacted by the crank pin 54.

Once the components reach the FIG. 2C position, a sensor (not shown) senses that the lever 655 is in the FIG. 2C position and indicates this to a logic controller (not shown), which in turn reverses the polarity of the electromagnetic coil 122. This then creates a north magnetic pole at the first stator magnetic pole 130 and a south magnetic pole at the second stator magnetic pole 132. This causes the rotor 120 to rotate in a counter-clockwise direction such that the proximate portion 146A of the second peg 146 engages and then moves the output member 112 in a counter-clockwise direction, returning both the rotor 120 and the output member 112 to near the FIG. 1D position. The output member 112 and the rotor 120 are prevented from returning fully to the FIG. 1D position because the tip 112A engages the arcuate edge 655A of the lever 655. When in this position, the output member 112 is approximately 20 degrees away from the FIG. 1D position. Nevertheless, because when the rotor 120 and the output member 112 are in the FIG. 1B position, the magnetic axis MA is angled at 40 degrees relative to the maximum torque position, when the tip 112A is engaged with the arcuate edge 655A the magnetic axis of the rotor 120 is still 20 degrees counter-clockwise from the maximum torque position. As such, even in this position when the power to the electromagnetic coil 122 is cut, there is still a torque acting on the rotor 120 in a counter-clockwise direction.

While the rotor 120 and the output member 122 are near the FIG. 1D position, the lever 655 is still in the FIG. 2C position. The lever 655 is returned to the FIG. 1D position as described below.

Considering FIG. 1C, the crank shaft 50 rotation upon opening is counter-clockwise about axis A, i.e., counter-clockwise relative to the latch chassis 12. The crank shaft axis A is defined by the cylindrical pin 56 being rotatably mounted in the retention plate (as mentioned above) and the boss 61 being rotatably mounted in the backplate 24 (as mentioned above). Accordingly, the crank shaft axis A is fixed relative to the latch chassis 12.

As mentioned above, when viewing FIG. 1C, the force FP generates a counter-clockwise torque upon the crank shaft 50 about the crank shaft axis A. Once the crank shaft 50 is freed to rotate (i.e., once the second arm 162 has disengaged from the release abutment 65), then the crank shaft 50 will move in a counter-clockwise direction since the crank pin axis Y is constrained to move about an arc centred on the crank shaft axis A. Since the pawl pivot hole 46 is a close running fit on the crank pin 54, then the pawl axis Z (i.e., the center of the pawl pivot hole 46) is coincident with the crank pin axis Y. Accordingly, the pawl axis Z is similarly constrained to move about an arc centred on crank shaft axis A.

As the crank shaft 50 starts to rotate in a counter-clockwise direction from the position shown in FIG. 1C, the rotating claw 14 starts to open. The action of the rotating claw 14 pushing on the compression pawl 16 causes the compression pawl 16 to move i.e., it is the rotating claw 14 that drives the compression pawl 16 to the disengaged position by virtue of the weather seal load acting on the rotating claw 14. As the compression pawl 16 moves, the angular position of the compression pawl 16 is controlled by engagement between the abutment surface 42 of the first arm 41 and the stop pin 29, more particularly the contact point B defined between the abutment surface 42 and part of the cylindrical outer surface 29A (which is also known as a chassis control surface).

The movement of the compression pawl 16 can be approximated to rotation about the contact point B (i.e., rotation about the contact point B between the abutment surface 42 and the cylindrical outer surface 29A). However, the movement is not truly rotational since a part of the compression pawl 16 (namely the pawl axis Z) is constrained to move about the axis A rather than about the contact point B. Thus, the movement of the compression pawl 16 at the contact point B relative to the stop pin 29 is a combination of rotational movement and transitional (sliding) movement. Indeed, the contact point B is not stationary and will move a relatively small distance around the cylindrical outer surface 29A, and will also move a relatively small distance along the abutment surface 42. Thus, the contact point B is the position where (at the relevant time during opening of the latch) the abutment surface 42 contacts the cylindrical outer surface 29A.

Starting from the FIG. 1C position, once the second arm 162 has disengaged from the release abutment 65, the closed abutment 34 of the rotating claw 14 pushes the compression pawl 16 (via the pawl tooth 40) to a position whereby the closed abutment 34 can pass under the pawl tooth 40 when viewing FIG. 1C. Continued counter-clockwise rotation of the rotating claw 14 (when viewing FIG. 1C) will cause the first safety abutment 33 to approach the pawl tooth 40. As this occurs, the pawl tooth 40 will momentarily engage the first safety abutment 33, since the compression pawl 16 is biased in a clockwise direction when viewing FIG. 1C by the spring 47. However, the geometry of the system is such that immediately after momentary engagement between first safety abutment 33 and the pawl tooth 40, the first safety abutment 33 pushes the compression pawl 16 (via the pawl tooth 40) to a position whereby the first safety abutment 33 continues to rotate in a counter-clockwise direction when viewing FIG. 1C under the pawl tooth 40.

Once the pawl tooth 40 has thus disengaged from first safety abutment 33 of the rotating claw 14, the rotating claw 14 is then free to rotate to the fully open position as shown in FIG. 3. However, in doing so, the reset pin 37 engages and then moves the edge 60A of the reset lever 54. This in turn rotates the crank shaft 50 back to the position shown in FIG. 1, thereby resetting the crank pin axis Y to the FIG. 1 position, and also returning the release arrangement 652 to the FIG. 1D position. In particular, as the lever 655 returns to the FIG. 1D position the torque acting on the rotor 120 in a counter-clockwise direction will cause the output member 112 to move the remaining 20 degrees to the FIG. 1D position, and this is in the absence of any power to the electromagnetic coil 122.

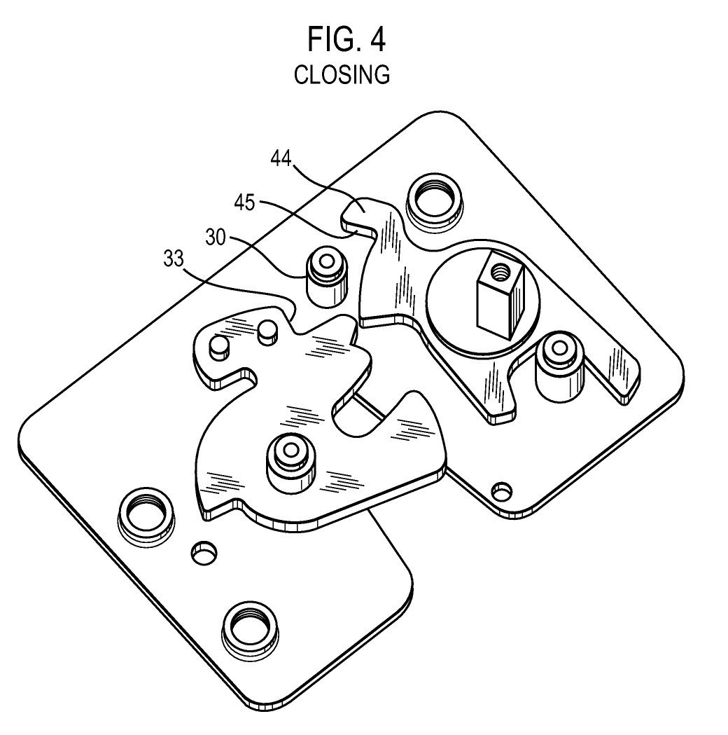

Once the latch and associated door has been opened, then closing of the door will automatically relatch the latch. Note however that no rotation of the crank shaft 50 occurs during closing of the door. Accordingly, the crank pin axis Y does not rotate and as such the crank pin 54 itself acts as a simple pivot having a fixed axis. FIG. 4 shows the latch assembly 10 during the closing process, and it can be seen that the compression pawl 16 is free to rotate about a pawl axis Z to provide conventional closing dynamics for the first safety and fully latched positions.

As mentioned above, a sensor is included to determine when the lever 655 reaches the FIG. 2C position, and upon this determination the electromagnetic coil 122 is reversed polarized to rotate the rotor in a counter-clockwise direction. Alternatively, the sensor could be arranged to determine when the lever 655 has been returned to the FIG. 1D position, and upon this determination the electromagnetic coil 122 can be reverse, polarized to rotate the rotor 120 in a counter-clockwise direction.

In an alternative embodiment, it is possible to power the electromagnetic coil 122 for a pre-determined short period of time. Also, the pre-determined time would be sufficient to ensure that the lever 655 reaches the FIG. 2C position. After the pre-determined time, the electromagnetic coil 122 would be reversed polarized to rotate the rotor in a counter-clockwise direction. Under these circumstances, the above mentioned sensor is not required.

In an alternative embodiment, a spring can be used to rotate the rotor 120 in a counter-clockwise direction once the lever 655 has reached the FIG. 2C position. Under these circumstances, the above mentioned sensor is not required.

In a yet further embodiment, the rotor 120, the first peg 144, the second peg 146, the motor stops 114 and 116, the output member 112 and the lever 655 can be configured so that less than 90 degrees of rotation of the rotor 120 is required, for example only 30 degrees of rotation is required. Under these circumstances, the rotor 120 will naturally return to the FIG. 1D position without the need to reverse polarize the electromagnetic coil 122 and without the need of a return spring. Thus, as shown in FIG. 1D the north pole N of the rotor 120 is approximately 45 degrees clockwise from the position where it aligns directly with the second stator magnetic pole 132 by configuring the system so that the latch is released by only 30 degrees of clockwise rotation of the rotor 120 from the FIG. 1D position, it will be appreciated that the north pole N at most is 75 degrees clockwise from direct alignment with the second stator magnetic pole 132. Because the rotor 120 then only ever moves between the 45 degree and 75 degree angles (and thus never reaches the FIG. 5C position), then at all times when the electromagnetic coil 122 is not energized, the magnetic forces acting on the rotor 120 will always tend to rotate it in a counter-clockwise direction. Thus, it is only ever necessary to power the electromagnetic coil 122 in one direction since the north pole N never gets past the 90 degree “dead center” position shown in FIG. 5C.

In the embodiments shown in FIGS. 1 to 4, a motor arrangement 100 is used to release a latch. In further embodiments, motor arrangements according to the present invention can be used to perform other functions on a latch. In particular, it can be used to change the security status of a latch. It is known for latches to have a locked security status and an unlocked security status, and it is known for motors to change the latch status between locked and unlocked. The present invention can be used to change a latch status between locked and unlocked.

It is also known for latches to include a child safety on security status and a child safety off security status. The present invention can be used to change the security status of a latch between the child safety on status and the child safety off status. It is also known for latches to have a superlocked security status and a non superlocked security status, and the present invention can be used to change a latch between a superlocked security status and a non superlocked security status.

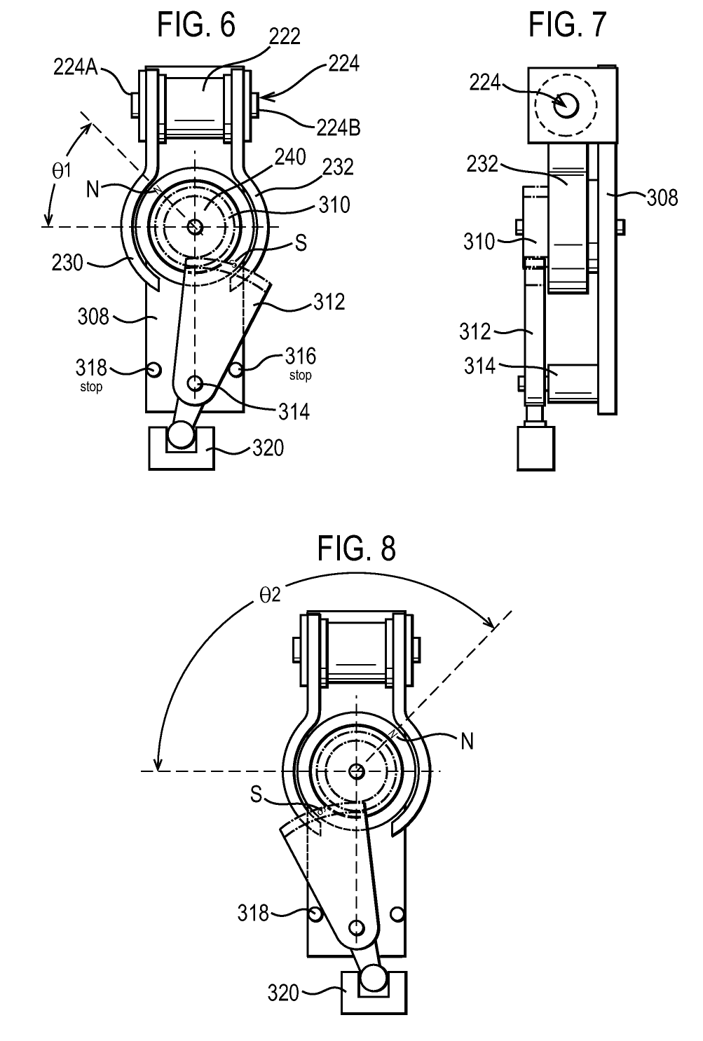

FIGS. 6 to 8 show a further embodiment of a motor arrangement 210 in which components which fulfil substantially the same function as those of motor arrangement 100 are labelled 100 greater. The motor arrangement is mounted on a plate 308. In this case, a gear 310 is rotatably fast with the rotor and is engaged by a gear sector 312 which is pivoted at a pivot 314.

Stops 316 and 318 limit clockwise and counter-clockwise rotation, respectively, of the gear sector and hence limit counter-clockwise and clockwise rotation of the rotor. In this case, the rotor is limited in its counter-clockwise direction such that the north pole is aligned at angle [symbol] (approximately 45 degrees) and the rotor is limited in its clockwise rotation such that the north pole is limited to angle [symbol] (approximately 135 degrees). The rotor therefore can move through approximately 90 degrees. FIG. 6 shows an output member 320 in a first position, and FIG. 8 shows the output member 320 in a second position.

The rotor positions shown at FIGS. 6 and 8 are both stable rotor positions. Furthermore, because the rotor 240 includes a permanent magnet, then in the absence of an electric current flowing through the electromagnetic coil 222, in the position shown at FIG. 6, the magnetic forces provide a counter-clockwise turning moment on the rotor 120 which is resisted by the stop 316. Similarly, in a position shown at FIG. 8, the magnetic forces acting on the rotor 120 create a clockwise moment which is resisted by the stop 318. Thus, the motor arrangement will naturally hold itself in the FIG. 6 position or the FIG. 8 position, as appropriate. This is particularly beneficial because in prior art locking systems and “overcenter” spring is typically required to hold the locking system in either the locked or unlocked condition. Such a spring is not required when the motor arrangement 210 shown in FIGS. 6 to 8 is used. The motor arrangement 410 (as described below) operates similarly, and also does not require an overcenter spring.

The output member 320 can be used to lock and unlock a latch. Alternatively, the output member 320 can be used to change between the child safety on status and the child safety off status of a latch. Alternatively, the output member 320 can be used to change between a superlocked condition of a latch and a non superlocked condition of a latch.

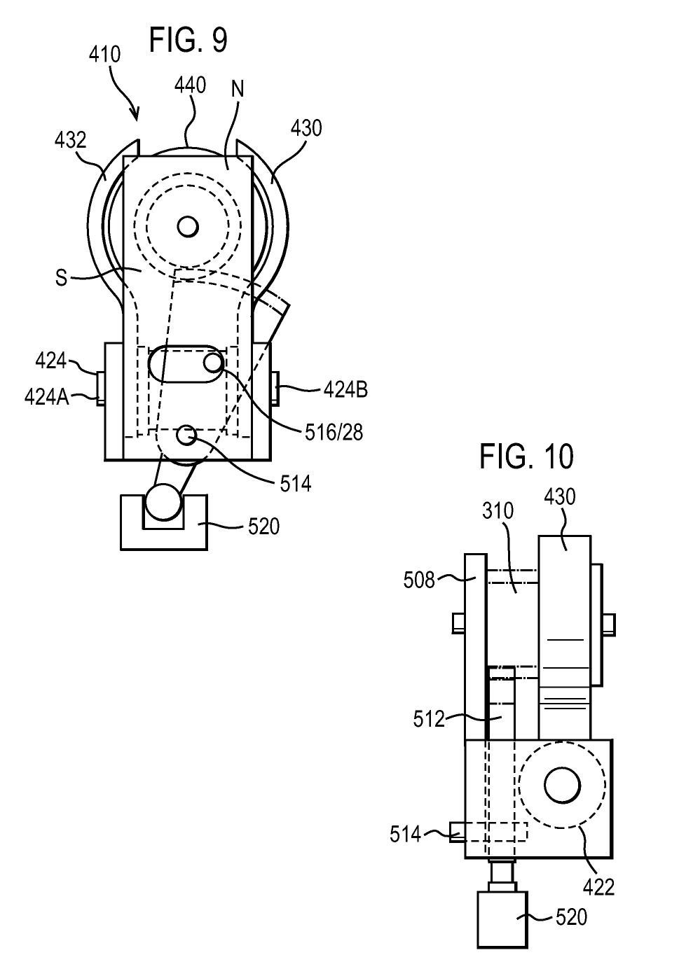

FIGS. 9 and 10 show a motor arrangement 410 in which components that fulfil substantially the same function as those shown in the motor arrangement 210 are labelled 200 greater. The motor arrangement 410 is more compact than the motor arrangement 210 because the gear sector 512 lies on the same side of the rotor as the coil 422.

As mentioned above, the rotor is limited to rotating through an angle of 70 degrees. However, in further embodiments, the rotational of the rotor could be limited to less than 180 degrees. However, in one example, the rotational movement of the rotor is less than 100 degrees, such as less than 90 degrees. This is because these are angles at which useful torque can be provided (see FIG. 11).

As mentioned above, the output member can rotate relative to the rotor by 35 degrees. In a further embodiment, different angles of rotation are possible, but in particular the output member may be rotatable relative to the rotor by more than 20 degrees, in one example, more than 30 degrees and in another example more than 40 degrees.

As mentioned above, the embodiment described has a total rotor movement of 70 degrees. The output member can rotate relative to the rotor by 35 degrees. This means that the output member rotates relative to the latch chassis by 35 degrees in total. In further embodiments, the output member could rotate relative to the latch chassis by other angles, but in one example the output member rotates relative to the latch chassis by less than the angle through which the rotor rotates relative to the latch chassis.

As mentioned above, FIG. 1B shows that the magnetic axis MA is positioned 40 degrees counter-clockwise relative to the maximum output position TMAX when the latch is in a closed position. When the coil is powered to open the latch, initially only the rotor starts to rotate. By the time the rotor has reaches the position shown in FIG. 2A″, it has an amount of rotational inertia that assists in overcoming the static friction between the tip 112A of the output member 112 and the associated notch in the lever 655. Furthermore, when the rotor is in the FIG. 2A″ position, it is nearly at its maximum torque output position (angle Y3 is only 5 degrees). Consideration of FIG. 11 shows that in spite of the magnetic axis MA not quite being aligned with TMAX, nevertheless the rotor is producing 99% of its maximum output. By arranging “lost motion” between the rotor and the output member, i.e., by allowing the rotor to rotate further than the output member, this allows low starting loads on the rotor (i.e., the rotor has only got to rotate itself when starting).

This lost motion also allows the rotor to achieve some rotational intertia before it is required to rotate the output member. The lost motion also allows the rotor to be at or near its maximum torque position before it is required to rotate the output member. The lost motion also allows the stable equilibrium positions to be positioned at relatively large angles from TMAX (in this case 40 degrees from TMAX (see FIG. 1B) and 30 degrees from TMAX (see FIG. 2C″)). The further the stable equilibrium positions are from TMAX, then the higher than torque on the rotor forcing it into engagement with the motor stops 114 and 116 (for the avoidance of doubt this is when no power is applied to the coil).

By ensuring that the angle of the stable equilibrium position from TMAX (for example 40 degrees (see FIG. 1B)) is approximately equal to the lost motion between the rotor and the output member (35 degrees (see FIG. 2A″)) means that the lost motion will be taken up at approximately the position when the magnetic axis MA of the rotor is at TMAX (5 degrees (as shown in FIG. 2A″ (Y3)). In other words, it is advantageous for the angle between the magnetic axis with the rotor in the stable equilibrium position and TMAX (40 degrees as shown in FIG. 1B) to be less than 20 degrees different from the amount of rotation between the output member and the rotor. In one example the angle is less than 10 degrees different, in another example, the angle (as in the embodiment shown in FIG. 2A″) is 5 degrees, and in another example the angle is less than 5 degrees different.

The brushless DC motor 110 is used to release the tip of the output member 112 from the lever 655. In further embodiments, the motor could be used in other mechanism to hold an abutment of the mechanism in the first position and then release that abutment to allow it to move to the second position.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A motor arrangement comprising:
a rotor with a north rotor magnetic pole and a south rotor magnetic pole, the rotor being rotatable about a rotor axis between a first rotor position and a second rotor position, the rotor including a first rotor abutment and a second rotor abutment;
a stator having a first stator magnetic pole and a second stator magnetic pole, the stator having a first stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole, wherein the first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole;
an output member being rotatable about the rotor axis and having a first output abutment engageable by the first rotor abutment to move the output member in a first rotational direction and having a second output abutment engageable by the second rotor abutment to move the output member in a second rotational direction, the output member being rotatable relative to the rotor to a limited extent defined by the first output abutment and the second output abutment and the first rotor abutment and the second rotor abutment;
a first stop to limit movement of the rotor past the first rotor position; and
a second stop to limit movement of the rotor past the second rotor position.

2. The motor arrangement as defined in claim 1 wherein the first stop and the second stop limit rotational movement of the rotor to less than 180 degrees.

3. The motor arrangement as defined in claim 1 wherein the output member is rotatable relative to the rotor by more than 20 degrees.

4. The motor arrangement as defined in claim 1 wherein the output member rotates less than the rotor when the rotor moves between the first rotor position and the second rotor position.

5. The motor arrangement as defined in claim 1 wherein the first rotor position is a first stable equilibrium position and the second rotor position is a second stable equilibrium position.

6. The motor arrangement as defined in claim 5 wherein there are only two stable equilibrium positions.

7. The motor arrangement as defined in claim 5 wherein the rotor has a further rotor position which is an unstable equilibrium position, the further rotor position being between the first rotor position and the second rotor position.

8. The motor arrangement as defined in claim 7 wherein the first rotor position is at a first angle from the further rotor position and the second rotor position is at a second angle from the further rotor position, the first angle and the second angle being different, wherein the first angle is greater than the second angle.

9. The motor arrangement as defined in claim 8 wherein the first angle is less than 20 degrees different to the amount of relative rotation between the output member and the rotor.

10. A mechanism comprising:
a motor arrangement including:
a rotor with a north rotor magnetic pole and a south rotor magnetic pole, the rotor being rotatable about a rotor axis between a first rotor position and a second rotor position, the rotor including a first rotor abutment and a second rotor abutment,
a stator having a first stator magnetic pole and a second stator magnetic pole, the stator having a first stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole, wherein the first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole,
an output member being rotatable about the rotor axis and having a first output abutment engageable by the first rotor abutment to move the output member in a first rotational direction and having a second output abutment engageable by the second rotor abutment to move the output member in a second rotational direction, the output member being rotatable relative to the rotor to a limited extent defined by the first output abutment and the second output abutment and the first rotor abutment and the second rotor abutment,
a first stop to limit movement of the rotor past the first rotor position, and
a second stop to limit movement of the rotor past the second rotor position; and
a mechanism abutment, wherein, with the rotor in the first rotor position, the output member engages the mechanism abutment to hold the mechanism abutment in a first mechanism abutment position and movement of the rotor to the second rotor position disengages the output member from the mechanism abutment, thereby allowing the mechanism abutment to move to a second mechanism abutment position.

11. A latch assembly comprising:
a chassis;
a latch bolt movably mounted on the chassis and having a closed position for retaining a striker and an open position for releasing the striker;
a pawl having an engaged position at which the pawl is engaged with the latch bolt to hold the latch bolt in the closed position and a disengaged position at which the pawl is disengaged from the latch bolt, thereby allowing the latch bolt to move to the open position;
an eccentric arrangement defining an eccentric axis and a pawl axis remote from the eccentric axis, wherein the eccentric arrangement is rotatable about the eccentric axis and the pawl is rotatable about the pawl axis,
wherein when the pawl moves from the engaged position to the disengaged position, the eccentric arrangement rotates in one of a clockwise and counter-clockwise direction about the eccentric axis, and with the pawl in the engaged position, a force applied to the pawl by the latch bolt creates a turning moment on the eccentric arrangement about the eccentric axis in the one of a clockwise and counter-clockwise direction, and the eccentric arrangement is prevented from rotating in the one of a clockwise and counter-clockwise direction by a moveable abutment; and
including;
a rotor with a north rotor magnetic pole and a south rotor magnetic pole, the rotor being rotatable about a rotor axis between a first rotor position and a second rotor position, the rotor including a first rotor abutment and a second rotor abutment.
a stator having a first stator magnetic pole and a second stator magnetic pole, the stator having a First stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole, wherein the first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole,
an output member being rotatable about the rotor axis and having a first output abutment engageable by the first rotor abutment to move the output member in a first rotational direction and having a second output abutment engageable by the second rotor abutment to move the output member in a second rotational direction, the output member being rotatable relative to the rotor to a limited extent defined by the first output abutment and the second output abutment and the first rotor abutment and the second rotor abutment,
a first stop to limit movement of the rotor past the first rotor position, and
a second stop to limit movement of the rotor past the second rotor position,
wherein the moveable abutment is defined by the output member, and the motor arrangement is operable to move the movable abutment to release the latch.

12. The latch assembly as defined in claim 11 wherein, with the rotor in the first rotor position, the output member engages the moveable abutment to hold the latch in a closed position, and movement of the rotor to the second rotor position disengages the output member from the moveable abutment, thereby allowing the latch to open.

13. The latch assembly as defined in claim 11 wherein the latch has a closed condition where the claw is in the closed position, the pawl is in the engaged position, and the pawl axis is in a first position, and the latch has an open condition where the claw is in the open position, the pawl is in the disengaged position, and the pawl axis is substantially in said first position.

14. The latch assembly as defined in claim 13 wherein, during movement of the latch bolt from the closed position to the open position, the eccentric arrangement rotates in the one of a clockwise and counter-clockwise direction such that the pawl axis moves to a second position and the latch bolt rotates the eccentric arrangement in the other of the clockwise and counter-clockwise direction such that the pawl axis is substantially returned to the first position.

15. The latch assembly as defined in claim 11 wherein the latch bolt engages a reset abutment of the eccentric arrangement to move the eccentric arrangement from the second position to the first position.

16. The latch assembly as defined in claim 15 wherein the reset abutment is defined on a reset lever of the eccentric arrangement.

17. A method of opening a latch, the method comprising the steps of;
providing a latch assembly including:
a chassis,
a latch bolt movably mounted on the chassis and having a closed position for retaining a striker and an open position for releasing the striker,
a pawl having an engaged position at which the pawl is engaged with the latch bolt to hold the latch bolt in the closed position and a disengaged position at which the pawl is disengaged from the latch bolt, thereby allowing the latch bolt to move to the open position,
an eccentric arrangement defining an eccentric axis and a pawl axis remote from the eccentric axis, wherein the eccentric arrangement is rotatable about the eccentric axis and the pawl is rotatable about the pawl axis, and
a moveable abutment,
putting the latch bolt in the closed position, the pawl in the engaged position, and the pawl axis in a first position,
causing the latch bolt to apply a force to the pawl to create a turning moment on the eccentric arrangement in one of a clockwise and counter-clockwise direction and reacting the turning moment at the moveable abutment to prevent movement of the eccentric arrangement,
subsequently moving the moveable abutment by operation of a motor arrangement the turning moment is no longer reacted, thereby allowing the force to move the eccentric arrangement in the one of a clockwise and counter-clockwise direction such that the pawl axis moves to a second position and the pawl moves to the disengaged position, allowing the latch bolt to move to the open position, thereby opening the latch, wherein the motor arrangement includes:
a rotor with a north rotor magnetic pole and a south rotor magnetic pole, the rotor being rotatable about a rotor axis between a first rotor position and a second rotor position, the rotor including a first rotor abutment and a second rotor abutment,
a stator having a first stator magnetic pole and a second stator magnetic pole, the stator having a first stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole, wherein the first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole,
an output member being rotatable about the rotor axis and having a first output abutment engageable by the first rotor abutment to move the output member in a first rotational direction and having a second output abutment engageable by the second rotor abutment to move the output member in a second rotational direction, the output member being rotatable relative to the rotor to a limited extent defined by the first output abutment and the second output abutment and the first rotor abutment and the second rotor abutment,
a first stop to limit movement of the rotor past the first rotor position, and
a second stop to limit movement of the rotor past the second rotor position.

18. The method of opening a latch as defined in claim 17 including the further steps of:
putting the latch bolt in the closed position and the pawl in the engaged position to retain the striker,
causing the striker to apply a force to the latch bolt, thereby causing the latch bolt to apply the force to the pawl, and
allowing the latch bolt to move to the open position, thereby releasing the striker and opening the latch.

19. The method of opening a latch as defined in claim 17 including the step of returning the pawl axis substantially to the first position during opening of the latch.

20. A latch assembly comprising;
a motor arrangement including:
a rotor with a north rotor magnetic pole and a south rotor magnetic pole, the rotor being rotatable about a rotor axis between a first rotor position and a second rotor position, the rotor including a first rotor abutment and a second rotor abutment,
a stator having a first stator magnetic pole and a second stator magnetic pole, the stator having a first stator condition in which the first stator magnetic pole is a north stator magnetic pole and the second stator magnetic pole is a south stator magnetic pole, and a second stator condition in which the first stator magnetic pole is a south stator magnetic pole and the second stator magnetic pole is a north stator magnetic pole, wherein the first stator condition corresponds to the first rotor position in which the north rotor magnetic pole is proximate the second stator magnetic pole and the south rotor magnetic pole is proximate the first stator magnetic pole, and the second stator condition corresponds to the second rotor position in which the north rotor magnetic pole is proximate the first stator magnetic pole and the south rotor magnetic pole is proximate the second stator magnetic pole,
an output member being rotatable about the rotor axis and having a first output abutment engageable by the first rotor abutment to move the output member in a first rotational direction and having a second output abutment engageable by the second rotor abutment to move the output member in a second rotational direction, the output member being rotatable relative to the rotor to a limited extent defined by the first output abutment and the second output abutment, and the first, rotor abutment and the second rotor abutment,
a first stop to limit movement of the rotor past the first rotor position, and
a second stop to limit movement of the rotor past the second rotor position,
wherein the latch assembly has alternate security statuses and is movable between the alternate security statuses by the motor arrangement.

21. The motor arrangement as defined in claim 2 wherein the first stop and the second stop limit rotational movement of the rotor to less than 100 degrees.
